(19) United States
(12) Patent Application Publication
(10) Pub. No.: US 2012/0270733 A1
(43) Pub. Date: Oct. 25, 2012

(54) COMPOSITIONS FOR IMPROVED SEED HANDLING CHARACTERISTICS

(75) Inventors: Sarah Cush, Greensboro, NC (US); Carolyn Moore, Greensboro, NC (US); Michael Hopkinson, Greensboro, NC (US)

(73) Assignee: SYNGENTA CROP PROTECTION LLC, Greensboro, NC (US)

(21) Appl. No.: 13/388,067

(22) PCT Filed: Jul. 30, 2010
(86) PCT No.: PCT/US2010/043813

§ 371 Date: Jul. 12, 2012

Related U.S. Application Data
(60) Provisional application No. 61/230,274, filed on Jul. 31, 2009.

(51) Int. Cl. A01C 1/06; A01N 43/88; A01P 9/00; A01P 7/02; A01P 5/00; A01N 25/24; A01P 7/04

(52) U.S. Cl. 504/100; 514/788; 514/229.2; 47/57.6

(57) ABSTRACT

The use of tetra(2-hydroxypropyl)ethylene diamine as a seed treatment.

### TECHNICAL FIELD

The present technology relates to seed treatments, and in particular seed treatments for improved seed handling characteristics.

### BACKGROUND

The use of pesticides to control pests in crops is a wide spread practice. This practice has gained a high degree of commercial success because it has been shown that such control can increase crop yield. Pesticides can be applied directly to plant propagation materials (such as seeds) prior to sowing and/or are used in foliar or furrow applications.

A seed treatment is any material applied to a seed. Examples of seed treatments include, inter alia, pesticides, non-pesticide formularies, and mixtures thereof. Non-pesticide formularies generally include material such as surfactants, humectants, fillers, and polymers that influence the treated seed characteristics. Seed treatments are generally used on a variety of crops to control a variety of pests. Seed treatments are commonly used to ensure uniform stand establishment by protecting against soilborne diseases and insects. Systemic seed treatments may provide an alternative to traditional broadcast sprays of foliar fungicides or insecticides for certain early season airborne diseases and insects.

Pesticide seed treatments come in a variety of formulations: dry flowables (DF), liquid flowables (LF), true liquids (TL), emulsifiable concentrates (EC), dusts (D), wettable powders (WP), suspoemulsions (SE), water-dispersible granules (WG) and others. Some are registered for use only by commercial applicators using closed application systems, others are readily available for on-farm use as dusts, slurries, water soluble bags, or liquid ready-to-apply formulations.

Commercial seed treatment often requires specialized equipment to properly apply treatments or to treat large volumes of seed. An important concern of the commercial treater is equipment performance to ensure the delivery of a proper amount of active ingredient to the seed. This has become especially important with more modern fungicides that require only small amounts of material.

Conveniently, many seed treatment materials also are available for on-farm use. These are known as hopper-box or planter-box treatments wherein liquid or dry formulations are applied to seed as it passes through an auger from the transport bin or truck to the planter boxes. These formulations are a very convenient way to apply seed treatment onto bulk seed right before planting. Conventional dry treatments generally are formulated with talc or graphite which adheres the treatment chemical to the seed. Conventional liquid hopper-box treatments generally are made available as a fast-drying formulations. In any case, good seed coverage is required for maximum benefit from any seed treatment formulation.

However, obtaining thorough seed coverage can be difficult when attempting to treat seed. For example, dry formulations can present unacceptable worker exposure to the fungicidal or insecticidal active ingredient. Problems can arise such as unacceptable drying times, material build-up in the seed treater, low seed flowability, poor seed coverage and dust-off of the pesticide from the seed prior to planting. As a result, handling is rendered difficult and the biological efficacy of the seed treatment may be reduced.

Seed coating additives are seed treatments used to remedy problems such as low seed flowability and excessive dust-off. However, it is well known that selection of a seed coating additive to reduce dust-off will likely have the adverse effect of decreasing seed flowability. Likewise, it is well known that selection of a seed coating to increase seed flowability will likely have the adverse effect of increasing dust-off.

### SUMMARY

The present technology provides for seed treatment compositions having improved flowability and improved adherence to plant propagation material with low dust-off. The compositions of the present technology have particular application in the protection of plant propagation materials, such as seeds, against pests when combined with one or more pesticides.

The present technology thus provides an improved seed treatment suitable for applying plant propagation materials. The seed treatment of the present technology includes the polyol of the formula Tetra(2-hydroxypropyl)ethylene-diamine. This type of poylol is sold by BASF under the trade name Quadrol®. In the past, industry uses of Quadrol® have included application as a neutralizing component for compounds containing acid groups. Quadrol® has also found uses in the detergent, cleaner, and metalworking industries. However, Applicants have found the application and use of Tetra(2-hydroxypropyl)ethylene-diamine for use in the agricultural industry, and particularly as a seed treatment.

### BRIEF DESCRIPTION OF THE DRAWINGS

FIG. 1 is a bar chart displaying the general trends of film forming polymers.

FIG. 2 is a bar chart displaying the general trends of film forming polymers compared with tetra(2-hydroxypropyl)ethylene-diamine (Quadrol®).

### DETAILED DESCRIPTION

Tetra(2-hydroxypropyl)ethylene-diamine (shown below) as a seed treatment yields the surprising result of, inter alia, a seed treatment that improves seed flowability while reducing dust-off.

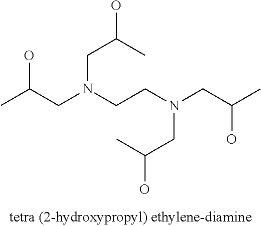

Tetra(2-hydroxypropyl)ethylene-diamine is commonly used as a surfactant outside the agricultural industry, however, inventors have found that tetra(2-hydroxypropyl)ethylene-diamine has advantageous characteristics not generally associated with surfactants. Advantageous seed treatment characteristics include improving seed flowability while also reducing dust-off, and are generally characteristics desired in a film-forming polymer. However, it is well known that selection of a seed coating additive, such as a film-forming polymer, to reduce dust-off will likely have the adverse effect of decreasing seed flowability. Likewise, it is well known that selection of a seed coating additive, such as a film-forming polymer, to increase seed flowability will likely have the adverse effect of increasing dust-off.

Seed treatment formulations applied to a seeds generally comprise a pesticide, surfactants, film-forming polymers, carriers, antifreeze agents, and other formulary additives and when used together provide compositions that are storage stable and are suitable for use in normal seed treatment equipment, such as a slurry seed treater, direct treater, panogen treater or a mist-o-matic treater as well as on-farm hopper-box or planter-box treatments. Propagation materials treated with the compositions dry quickly, have good flowability, suitable coverage and have little or no dust-off. The compositions are advantageously combined with a pesticidally effective amount of at least one pesticide.

### Tetra(2-hydroxypropyl)ethylene-diamine

Compositions created using the present technology include tetra(2-hydroxypropyl)ethylene-diamine. The compositions generally contain from about 0.5% to about 10% by weight of the composition of tetra(2-hydroxypropyl)ethylene-diamine. In a specific embodiment, the compositions contain from about 1.0% up to about 5% by weight of tetra(2-hydroxypropyl)ethylene-diamine.

Pesticides

The term “pesticide” as utilized herein is intended to cover compounds active against pests which are intended to repel, kill, or control any species designated a pest including weeds, insects, rodents, fungi, bacteria, or other organisms.

Examples of individual compounds of the above mentioned compound classes are listed below. Where known, the common name is used to designate the individual compounds (q.v. the Pesticide Manual, 12th edition, 2001, British Crop Protection Council).

Examples of pesticides include those selected from, for example and not for limitation, insecticides, acaricides, bactericides, fungicides, nematicides and molluscicides.

Suitable additions of insecticidally, acaricidally, nematicidally, or molluscicidally active ingredients are, for example and not for limitation, representatives of the following classes of active ingredients: organophosphorus compounds, nitrophenols and derivatives, formamidines, triazine derivatives, nitroenamine derivatives, nitro- and cyanoguanidine derivatives, ureas, benzoylureas, carbamates, pyrethroids, chlorinated hydrocarbons and Bacillus thuringiensis products. Especially preferred components in mixtures are abamectin, cyanoimine, acetamiprid, thiodicarb, nitromethylene, nitenpyram, clothianidin, dinotefuran, fipronil, lufenuron, pyripfoxyfen, thiacloprid, fluxofenime; imidacloprid, thiamethoxam, Chloranthraniliprole, beta cyfluthrin, lambda cyhalothrin, fenoxycarb, diafenthiuron, pymetrozine, diazinon, disulphoton; profenofos, furathiocarb, cyromazin, cypermethrin, tau-fluvalinate, spinetoram, spinosad, sulfloxaflor, tefluthrin or Bacillus thuringiensis products, very especially abamectin, thiodicarb, cyanoimine, acetamiprid, nitromethylene, nitenpyram, clothianidin, dinotefuran, flpronil, thiacloprid, imidacloprid, thiamethoxam, chloranthraniliprole, beta cyfluthrin, lambda cyhalothrin, and tefluthrin.

Suitable additions of fungicidally active ingredients are, for example and not for limitation, representatives of the following classes of active ingredients: strobilurins, triazoles, ortho-cyclopropyl-carboxanilide derivatives, phenylpyrroles, and systemic fungicides. Examples of suitable additions of fungicidally active ingredients include, but are not limited to, the following compounds: azoxystrobin; bitertanol; carboxin; Cu₂O; cymoxanil; cyproconazole; cyprodinil; dichlofluamid; difenoconazole; diniconazole; epoxiconazole; fenpiclonil; fludioxonil; fluoxastrobin, fluquiconazole; flusilazole; flutriafol; furalaxyl; guazatin; hexaconazole; hymexazol; imazalil; imibenconazole; ipconazole; kresoxim-methyl; mancozeb; metalaxyl; mefenoxam; metconazole; myclobutanil, oxadixyl, pefurazoate; penconazole; pencycuron; prochloraz; propiconazole; pyroquilone; (±)-cis-1-(4-chlorophenyl)-2-(1H-1,2,4-triazol-1-yl)cycloheptanol; sedaxane; spiroxamin; tebuconazole; thiabendazole; tolifluamide; triazoxide; triadimefon; triadimenol; trifloxystrobin, triflumizole; triticonazole and uniconazole. Particularly preferred fungicidally active agents include azoxystrobin, difenoconazole, fludioxonil, thiabendazole, tebuconazole, metalaxyl, mefenoxam, myclobutanil, fluoxastrobin, tritaxonazole, sedaxane, and trifloxystrobin.

In one embodiment, the pesticidally active compound or compound mixture is present in the composition in an amount of from about 0.05% to about 50% by weight, more specifically, from 2 to about 30% by weight of the entire composition.

Seed treatment application rates with respect to pesticidally active ingredients (compounds) are preferably 0.5 to 1000 g of pesticidally active compound per 100 kg seed. More preferred application rate ranges with respect to seed treatments include: 0.5 to 500 g of pesticidally active compound per 100 kg seed; 0.5 to 250 g of pesticidally active compound per 100 kg seed; 0.5 to 100 g of pesticidally active compound per 100 kg seed; 0.5 to 75 g of pesticidally active compound per 100 kg seed; and 0.5 to 55 g of pesticidally active compound per 100 kg seed.

Surface Active Agent

Seed treatment compositions may also contain at least about 2% up to about 15% by weight of a surface-active agent. Compositions may contain from 3% up to 7% by weight of a surface-active agent.

Generally the surface-active agent may comprise at least one nonionic surfactant and may optionally further comprise one or more anionic surfactants.

Exemplary nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, and mono- and diesters of ethylene glycol and mixtures thereof.

Specific examples of nonionic sufactants include: Genapol X-060 (Clariant) (ethoxylated fatty alcohol); Sorpohor BSU (Rhodia) ethoxylated tristyrylphenol; Makon TD-6 (Stepan) (ethoxylated fatty alcohol); BRIJ 30 (Uniqema) (ethoxylated lauryl alcohol); Witconol CO-360 (Witco) (ethoxylated castor oil); and Witconol NP-60 (Witco) (ethoxylated nonylphenol). Suitable nonionic surfactants can be prepared by methods known per se and also are commercially available.

In general, the anionic surfactant may be any known in the art. Anionic surfactants are in general oligomers and polymers, as well as polycondensates, which contain a sufficient number of anionic groups to ensure their water-solubility. Anionic surfactants also include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl—N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Specific examples of anionic surfactants include: Geropon T77 (Rhodia) (N-methyl-N-oleoyltaurate Na salt); Soprophor 4D384 (Rhodia) (tristyrylphenol sulphate); Reax 825 (Westvaco) (ethoxylated lignin sulfonate); Stepfac 8171 (Stepan) (ethoxylated nonylphenol phosphate ester); Ninate 401-A (Stepan) (calcium alkylbenzene sulfonate); Emphos CS-131 (Witco) (ethoxylated nonylphenol phosphate ester); Ufoxane 3A, NA (sodium lignosulphonate); Morwet D425 (sodium alkylnapthalenesulfonate), Reax 1425E (lignin sulfonate ethoxylate), and Atphos 3226 (Uniqema) (ethoxylated tridecylalcohol phosphate ester). Suitable anionic surfactants can be prepared by methods known per se and also are commercially available.

In addition to anionic and nonionic surfactants, certain cationic or zwitterionic surfactants also are suitable for use in the present invention such as alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈₋₁₈ fatty amine polyalkoxylates.

Mixtures of non-ionic and anionic surfactants and optionally cationic or zwitterionic surfactants may be employed as follows: (1) 0.5-4% by weight of a wetting agent selected from at least one anionic surfactant. Anionic surfactant wetting agents include sulfoalkylamides and salts thereof such as N-methyl—N-oleoyltaurate Na salt, alkylaryl sulfonates such as alkylbenzene sulfonates and alkylnaphthalene sulfonates and salts thereof and salts of ligninsulfonic acid; (2) 1-4% by weight of a dispersing agent selected from at least one anionic surfactant. Anionic surfactant dispersing agents include sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts; (3) 1 to 5% by weight of an emulsifying agent selected from at least one anionic surfactant, at least one nonionic surfactant and a mixture thereof. Suitable anionic/nonionic surfactant emulsifiers include salts of ethoxylated alkylphenols, polyoxyethylene-polyoxypropylene alkylphenols, (fatty) alcohol ethoxylates and ethoxylated tristyrylphenols.

Humectant

Seed treatment compositions may also include a humectant. A humectant is hygroscopic substance used to retain water. The compositions generally contain from 1% to 30% by weight of the composition. By way of example, and not by limitation, commonly used formulation humectants include antifreezes, for example ethylene glycol, propylene glycol and glycerin.

Film-Forming Polymer

Seed treatment composition may also include at least one polymer selected from water-soluble and water-dispersible film-forming polymers. Suitable polymers generally have an average molecular weight of at least about 1,000 up to about 100,000; more specifically at least about 5,000, up to about 100,000. The compositions generally contain from about 0.5% to about 10% by weight of the composition of polymer. In a specific embodiment, the compositions contain from about 1.0% up to about 5% by weight of a film-forming polymer.

Polymers are generally selected from alkyleneoxide random and block copolymers such as ethylene oxide-propylene oxide block copolymers (EO/PO block copolymers) including both EO-PO-EO and PO-EO-PO block copolymers, ethylene oxide-butylene oxide random and block copolymers, C₂₋₆ alkyl adducts of ethylene oxide-propylene oxide random and block copolymers, C₂₋₆ alkyl adducts of ethylene oxide-butylene oxide random and block copolymers. Prospective polymers further include polyoxyethylene-polyoxypropylene monoalkylethers such as methyl ether, ethyl ether, propyl ether, butyl ether or mixtures thereof; vinylacetate/vinylpyrrolidone copolymers; alkylated vinylpyrrolidone copolymers; polyvinylpyrrolidone; and polyalkyleneglycol including the polypropylene glycols and polyethylene glycols.

Specific examples of polymers include Pluronic P103 (BASF) (EO-PO-EO block copolymer), Pluronic P65 (BASF) (EO-PO-EO block copolymer), Pluronic P108 (BASF) (EO-PO-EO block copolymer), Vinamul 18160 (National Starch) (polyvinylacetate), Agrimer 30 (ISP) (polyvinylpyrrolidone), Agrimer VA7w (ISP) (vinyl acetate/vinylpyrrolidone copolymer), Agrimer AL 10 (ISP) (alkylated vinylpyrrolidone copolymer), PEG 400 (Uniqema) (polyethylene glycol), Pluronic R 25R2 (BASF) (PO-EO-PO block copolymer), Pluronic R 31R1 (BASF) (PO-EO-PO block copolymer) and Witconol NS 500LQ (Witco) (butanol PO-EO copolymer).

Antifreeze

The composition may also comprise an antifreeze from about 2 and up to about 30% by weight.

Specific examples of antifreezes include ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol and the like.

As a particular subset of suitable antifreeze materials there can be mentioned ethylene glycol, propylene glycol and glycerin.

Additional Components

The composition may also contain (e) at least one thickener.

In one embodiment, the thickener is present in the aqueous composition in an amount from about 0.01% to about 25% w/w, more specifically from 0.02 to 10% by weight of the entire composition.

Illustrative of thickeners (water-soluble polymers which exhibit pseudoplastic properties in an aqueous medium) are gum arabic, gum karaya, gum tragacanth, guar gum, locust bean gum, xanthan gum, carrageenan, alginate salt, casein, dextran, pectin, agar, 2-hydroxyethyl starch, 2-aminoethyl starch, 2-hydroxyethyl cellulose, methyl cellulose, carboxymethyl cellulose salt, cellulose sulfate salt, polyacrylamide, alkali metal salts of the maleic anhydride copolymers, alkali metal salts of poly(meth)acrylate, and the like.

As suitable thickeners there may also be mentioned attapulgite-type clay, carrageenan, croscarmellose sodium, furcelleran, glycerol, hydroxypropyl methylcellulose, polystyrene, vinylpyrrolidone/styrene block copolymer, hydroxypropyl cellulose, hydroxypropyl guar gum, and sodium carboxymethylcellulose.

The composition according to the invention can be employed together with the adjuvants customary in formulation technology, biocides, biostats, emulsifiers (lethicin, sorbitan, and the like), antifoam agents or application-promoting adjuvants customarily employed in the art of formulation. In addition, there may be mentioned inoculants and brighteners.

Additionally, a coloring agent, such as a dye or pigment (and the like such as described in the CFR 180.1001) is included in the seed coating so that an observer can immediately determine that the seeds are treated. The dye is also useful to indicate to the user the degree of uniformity of the coating applied.

The inventive compositions contain and/or may be applied together or sequentially with further active compounds. These further compounds can be fertilizers or micronutrient donors or other preparations that influence plant growth. They can also be selective herbicides, insecticides, fungicides, bactericides, insect growth regulators, plant growth regulators, nematicides, molluscicides or mixtures of several of these preparations.

Process

The pesticidal compositions of the invention can be prepared by processes known in the art.

In one embodiment, the compositions of the invention can be prepared by a process which comprises the steps: (a) forming a premix with at least one pesticidal compound, at least one surfactant, and water (b) forming a premix of a thickener and water, and (c) sequentially adding the premixes (a) and (b), tetra(2-hydroxypropyl)ethylene-diamine, the remaining ingredients, and water while stirring to form a homogeneous composition.

In another embodiment, the compositions of the invention can be prepared by combining commercially available seed treatment formulations with tetra(2-hydroxypropyl)ethylene-diamine.

Compositions

Pesticidal compositions in accordance with the invention may take the form of aqueous solutions, dispersions, suspensions, emulsions or suspoemulsions. In one embodiment, the composition is a ready for use suspension or suspoemulsion.

Use

The terms plant propagation material and seed, as defined herein, encompass both true seeds and other types of plant propagation material from which plants grow. Plant propagation material itself is commonly referred to as a seed and is defined as such herein. Many seed treatments are applied to true seeds, which have a seed coat surrounding an embryo. Seed treatments are also applied to plant propagation materials such as rhizomes, bulbs, corms or tubers.

In general, the amount of fungicide, insecticide or other ingredients used in the seed treatment are employed in amounts that do not inhibit generation of the seed or cause phytotoxic damage to the seed. The total amount of active ingredients is generally in the range of from about 0.05% to about 50% by weight, more specifically, from 2 to about 20% by weight of the entire composition.

Suitable target seeds are especially those of corn, potatoes, cereals, (wheat, barley, rye, oats, rice), maize, sugar beet, cotton, millet varieties such as sorghum, sun flowers, beans, peas, oil plants such as canola, rape, soybeans, cabbages, tomatoes, eggplants (aubergines), pepper and other vegetables and spices as well as ornamental shrubs and flowers. Suitable target seeds also include those of transgenic crop plants of the foregoing varieties.

Suitable application rates of (tetra(2-hydroxypropyl)ethylene-diamine) to plant seeds is between 0.05 to 10.0 g/500 g seed; 0.1 to 5.0 g/500 g seed; 0.1 to 2.5 g/500 g seed; 0.1 to 1.0 g/500 g seed; and preferably between 0.25 to 1.0 g/500 g seed.

The techniques of seed treatment application are well known to those skilled in the art, and they may be used readily in the context of the present invention. The compositions of the invention are applied to the seed as slurry or a soak. There also may be mentioned, e.g., film coating or encapsulation. The coating processes are well known in the art, and employ, for seeds, the techniques of film coating or encapsulation, or for the other multiplication products, the techniques of immersion. The method of application of the inventive compositions to the seed may be varied and the technology is intended to include any technique that is to be used.

As noted above, the compositions of the present technology may be formulated or mixed in the seed treater tank or combined on the seed by overcoating with other seed treating agents. The agents to be mixed with the compounds of this invention may be for the control of pests, nutrition, and the control of plant diseases.

A feature of the technology is that it provides for a treated seed with increased adherence which results in decreased dustiness and the subsequent elimination of related dust problems. Elimination of the dust associated with many seed treatments also eliminates the associated health hazards to those who work with treated seeds, such as processing plant employees, truck drivers, warehouse workers, and farmers.

Another feature of the technology is that it provides for a treated seed with increased flowability that that prevents against seed bridging. Seed bridging generally occurs during the removal of seeds from hopper-type storage. During storage treated seeds may have a tendency to stick together and during removal from storage the seeds at the bottom of the hopper storage will create a void while the top seeds create the bridge over the void. To continue removing the seeds the bridge must be broken. Because of the large size of hopper storage, or unfamiliarity with the danger of doing so, breaking the bridge is sometimes facilitated by a person climbing into the hopper and manually breaking the bridge. This act is very dangerous; a person may fall through the bridge and directly into the removal equipment (e.g. auger or conveyer belt) and/or being suffocated by seeds which have now fallen upon breaking of the bridge.

Still another feature of the technology is the uniform coating of-seeds with non-dusting seed treatment which will not interfere with germination and sprouting of the seed but which will protect the seed against seed-borne pathogens.

### EXAMPLES

In order that those skilled in the art will be better able to practice the technology, the following examples are given by way of illustration and not by way of limitation. In the following examples, as well as elsewhere in the specification and claims, temperatures are in degrees Celsius, the pressure is atmospheric and all parts are by weight, unless otherwise clearly indicated.

### Example 1

### General Trends of Film Forming Polymers: Increased Flowability Leads to Increased Dust-Off

N46J7 Variety Corn Seeds were treated as directed by label in a HEGE liquid seed treater with Cruiser® 5FS (0.25 mg ai/seed), Maxim®XL (0.0089 mg ai/seed), and Dynasty® (0.0025 mg ai/seed). Various seed treatment polymers were added to the treatment slurry prior to the seed application to obtain a rate of 0.34 g/500 g seed. Dust-off (g), wet flow (g/sec), and dry flow (g/sec) measurement were taken. Cruiser® contains the active ingredient thiamethoxam, Maxim®XL contains the active ingredients fludioxonil and metalaxyl-M, and Dynasty® contains the active ingredient azoxystrobin.

Dust-off was measured by placing 50 g of dry treated seeds in a rotary vacuum filtration machine for 5 minutes. Dust was collected onto 5 μm, 47 mm filter paper.

Wet flow Measurement—Seeds are taken immediately from the treater and are weighed. The seeds are then placed in a Cox funnel having a 1.25 inch opening at the stem. The funnel door is opened and a stopwatch concurrently started. The funnel may be tapped lightly if seeds begin to clump. The stopwatch is stopped when the last seed flows from the funnel. The seeds are poured back into the funnel two times and the above procedure repeated for a total of three measurements. The flow measurements are then calculated and averaged.

Dry flow Measurement—Seeds are taken from the treater and allowed to dry completely (approximately 24 hours) and are then weighed. The seeds are then placed in a Cox funnel having a 1.25 inch opening at the stem. The funnel door is opened and a stopwatch concurrently started. The funnel may be tapped lightly if seeds begin to clump. The stopwatch is stopped when the last seed flows from the funnel. The seeds are poured back into the funnel two times and the above procedure repeated for a total of three measurements. The flow measurements are then calculated and averaged.

CF-Clear™ is a polymer seed film manufactured by Becker Underwood for use as a seed treatment.

Secure™ is a polymer seed film manufactured by Becker Underwood for use as a seed treatment.

FloRite™ 1085 is polymer seed film manufactured by Becker Underwood for use as a seed treatment.

TABLE 1

| | Wet Flow | Dry Flow | Dust-Off |
|---|---|---|---|
| | (g/sec) | (g/sec) | (g) |
| CF Clear | 50.4 | 59.69 | 0.0014 |
| Secure | 44.69 | 68.97 | 0.0018 |
| FloRite 1085 | 53.69 | 75.76 | 0.0039 |

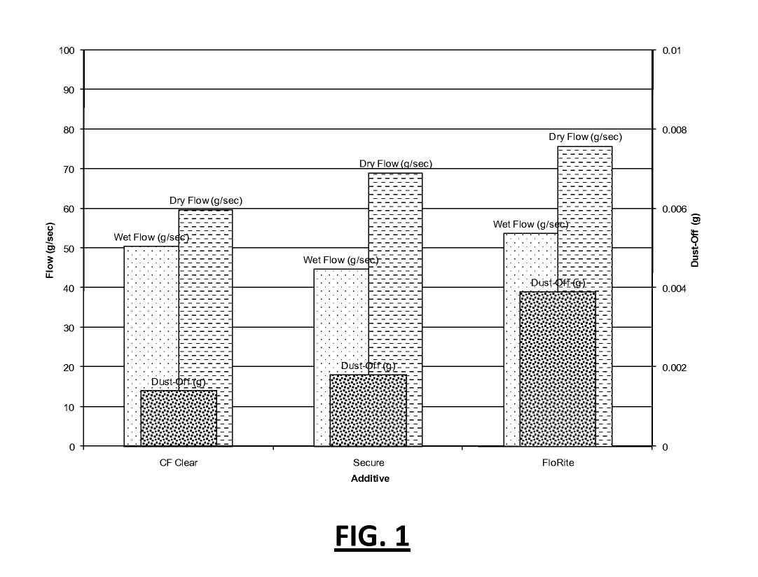

As shown in Table 1 and FIG. 1, the general trends of common film forming polymers leads to the expected result where increased flowability leads to increased dust-off.

### Example 2

### Expected Trends of Film Forming Polymers Vs. Quadrol

N46J7 Variety Corn Seeds were treated as directed by label in a HEGE liquid seed treater with Cruiser® 5FS (0.25 mg ai/seed), Maxim®XL (0.0089 mg ai/seed), and Dynasty® (0.0025 mg ai/seed). Quadrol® (tetra(2-hydroxypropyl)ethylene-diamine) was added to the treatment slurry prior to seed application to obtain a rate of 0.34 g/500 g seed. Dust-off (g), wet flow (g/sec), and dry flow (g/sec) measurement were taken as described above and are shown below with the previous polymers of Example 1.

TABLE 2

| | Wet Flow | Dry Flow | Dust-Off |
|---|---|---|---|
| | (g/sec) | (g/sec) | (g) |
| CF Clear | 50.4 | 59.69 | 0.0014 |
| Secure | 44.69 | 68.97 | 0.0018 |
| FloRite 1085 | 53.69 | 75.76 | 0.0039 |
| Quadrol | 64.31 | 69.93 | 0.0019 |

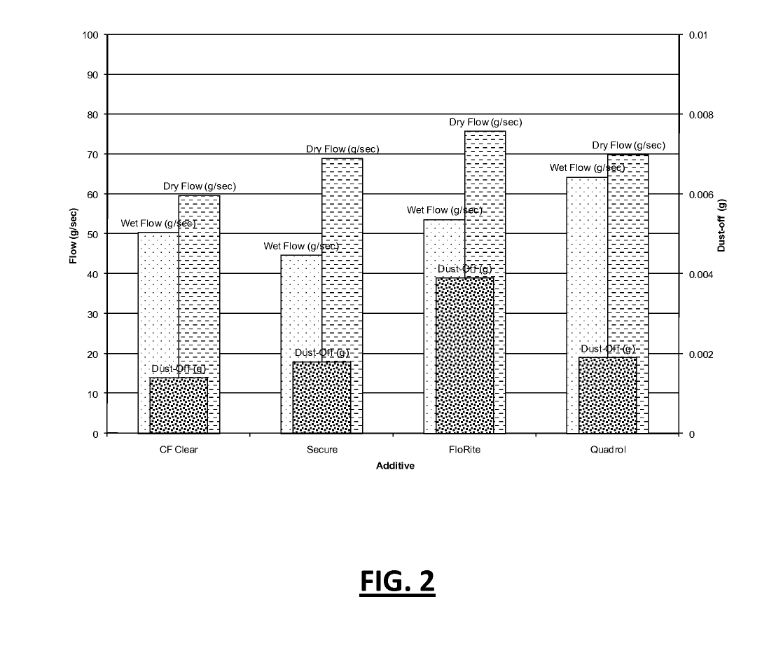

As shown in Table 2 and FIG. 2, the application of Quadrol® (tetra(2-hydroxypropyl)ethylene-diamine) results in increased flowability and decreased dust-off.

1. A method comprising:
applying tetra(2-hydroxypropyl)ethylene-diamine to a plant seed.

2. A plant seed having tetra(2-hydroxypropyl)ethylene-diamine applied to said plant seed.

3. The plant seed of claim 2 wherein the tetra(2-hydroxypropyl)ethylene-diamine is applied at a rate of from 0.05 to 10 g/500 g seed.

4. The plant seed of claim 2, wherein the tetra(2-hydroxypropyl)ethylene-diamine is applied at a rate from 0.1 to 2.5 g/500 g seed.

5. The plant seed of claim 2, wherein the tetra(2-hydroxypropyl)ethylene-diamine is applied at a rate of between 0.25 to 1.0 g/500 g seed.

6. The plant seed of claim 2 further comprising a pesticidally active ingredient applied to the plant seed.

7. The plant seed of claim 3 further comprising a pesticidally active ingredient applied to the plant seed.

8. The plant seed of claim 4 further comprising a pesticidally active ingredient applied to the plant seed.

9. The plant seed of claim 5 further comprising a pesticidally active ingredient applied to the plant seed.

10. The plant seed of claim 2 wherein the pesticidally active ingredient is applied at a rate from 0.5 to 1000 g/100 kg seed.

11. The plant seed of claim 9 wherein the pesticidally active ingredient is applied at a rate from 0.0025 to 0.275 g/500 g seed.

12. A composition comprising:
a pesticidally active ingredient;
a surface active agent;
a humectant; and
tetra(2-hydroxypropyl)ethylene-diamine.

13. The composition of claim 12, wherein the concentration of the pesticidally active ingredient is from 0.05 to 50% w/w.

14. The composition of claim 13 wherein the pesticidally active ingredient is thiamethoxam.

15. The composition of claim 12, wherein the concentration of tetra(2-hydroxypropyl)ethylene-diamine is from 0.5 to 10% w/w.

16. The composition of claim 15, wherein the concentration of tetra(2-hydroxypropyl)ethylene-diamine is from 1.0 to 5% w/w.

17. The method of claim 1, further comprising applying a pesticidally active ingredient to a plant seed.

18. The method of claim 17, wherein the pesticidally active ingredient is thiamethoxam.

19. The method of claim 18, wherein the plant seed is a corn seed.

20. The method of claim 18, wherein the plant seed is a cotton seed.
